(19) United States
(12) Patent Application Publication
(10) Pub. No.: US 2024/0212898 A1
(43) Pub. Date: Jun. 27, 2024

(54) GRADIENT RING-SHAPED BONDED MAGNET AND PREPARATION METHOD THEREFOR, AND MOTOR

(71) Applicants: GRIREM HI-TECH CO., LTD., Langfang (CN); GRIREM ADVANCED MATERIALS CO., LTD., Beijing (CN)

(72) Inventors: Yang LUO, Beijing (CN); Ze ZHANG, Beijing (CN); Zilong WANG, Beijing (CN); Yuanfei YANG, Beijing (CN); Wenlong YAN, Beijing (CN); Dunbo YU, Beijing (CN); Tianhao LI, Beijing (CN); Wenjian YAN, Beijing (CN); Tengfei HU, Beijing (CN)

(73) Assignees: GRIREM HI-TECH CO., LTD., Langfang (CN); GRIREM ADVANCED MATERIALS CO., LTD., Beijing (CN)

(21) Appl. No.: 18/486,440

(22) Filed: Oct. 13, 2023

(30) Foreign Application Priority Data
Dec. 27, 2022 (CN) 202211687071.4

(51) Int. Cl. H01F 1/057; H01F 1/055; H01F 41/02; H02K 15/03

(52) U.S. Cl. CPC H01F 1/0578; H01F 1/0558; H01F 41/0266; H01F 41/028; H02K 15/03

(57) ABSTRACT

Disclosed are a gradient ring-shaped bonded magnet and a preparation method therefor, and a motor. The gradient ring-shaped bonded magnet includes: a magnet body and at least one reinforcement layer. The magnet body is a ring-shaped cylinder; the reinforcement layer is in pressing fit with a surface of the magnet body; a material of the magnet body is a first permanent magnet, and a material of the reinforcement layer is a second permanent magnet; and the coercivity property, the remanence property and/or the maximum working temperature of the second permanent magnet are/is higher than those of the first permanent magnet.

### CROSS-REFERENCE TO RELATED APPLICATIONS

This application claims priority to Chinese Patent Application No. 202211687071.4 filed on Dec. 27, 2022, the content of which is incorporated herein by reference in its entirety.

### TECHNICAL FIELD

The present application relates to the field of processing of a magnet body for a motor, and in particular, to a gradient ring-shaped bonded magnet and a preparation method therefor, and a motor.

### BACKGROUND

At present, surface-mounted permanent magnet motors are widely applied to all walks of life due to their advantages of high efficiency, high power density and simple structure. Meanwhile, the surface-mounted permanent magnet motors have some disadvantages. The surface-mounted permanent magnet motors directly face the armature reaction of motor stators, thereby having high temperature and demagnetization risk. Dysprosium, terbium and other elements can effectively improve the coercivity of neodymium iron boron and other magnetic materials, but dysprosium, terbium and other elements are expensive, thereby increasing the cost of permanent magnet materials. Sintered neodymium iron boron and other magnets can achieve the local reinforcement of the permanent magnet materials through selected area grain boundary diffusion, such that less precious metal elements such as dysprosium and terbium can be used while the coercivity of the permanent magnet is effectively improved. However, a bonded magnet has no corresponding means to achieve local reinforcement at present, and a side close to a stator armature is prone to demagnetization to cause loss of excitation of the motor. According to the method provided by the present application, the local demagnetization resistance of the ring-shaped bonded magnet can be effectively improved, and the use amount of the precious metals such as dysprosium and terbium can be saved.

### SUMMARY

An objective of examples of the present application is to provide a gradient ring-shaped bonded magnet and a preparation method therefor, and a motor. A reinforcement layer is arranged on a surface of a magnet body, so that the local demagnetization resistance and high-temperature resistance of the ring-shaped bonded magnet can be effectively improved, and the use amount of precious metals such as dysprosium and terbium can be effectively saved.

To solve the above technical problem, a first aspect of the examples of the present application provides a gradient ring-shaped bonded magnet, including: a magnet body and at least one reinforcement layer. The magnet body is a ring-shaped cylinder; the reinforcement layer is in pressing fit with a surface of the magnet body; and a material of the magnet body is a first permanent magnet, a material of the reinforcement layer is a second permanent magnet, and the coercivity property, the remanence property and/or the maximum working temperature of the second permanent magnet are/is higher than those of the first permanent magnet.

Further, a material of the first permanent magnet and a material of the second permanent magnet include: neodymium iron boron, samarium iron nitrogen and/or samarium cobalt.

Further, the reinforcement layer is a ring-shaped cylinder; an inner wall of the magnet body is in pressing fit with a radial outer wall of the reinforcement layer; or an outer wall of the magnet body is in pressing fit with a radial inner wall of the reinforcement layer.

Further, the reinforcement layer is a ring-shaped cylinder, and an inner diameter and an outer diameter of the reinforcement layer are the same as those of the magnet body; in a case that one reinforcement layer is provided, an axial side wall of the reinforcement layer is in pressing fit with a side wall of one axial end of the magnet body; or in a case that one reinforcement layer is provided, the magnet body includes a first body and a second body which are ring-shaped cylinders, a side wall of one axial end of each of the first body and the second body is in pressing fit with side walls of two axial ends of the reinforcement layer, respectively; or in a case that two reinforcement layers are provided, axial side walls of the reinforcement layers are in pressing fit with side walls of two axial ends of the magnet body.

Further, a radial inner wall or a radial outer wall of the magnet body is provided with a plurality of grooves; the reinforcement layer includes a plurality of arc-sheet-shaped reinforcement bodies matched with the shapes of the grooves; and the reinforcement bodies are arranged in the grooves, and the reinforcement bodies are in pressing fit with the bottoms of the grooves.

Correspondingly, a second aspect of the examples of the present application provides a preparation method for a gradient ring-shaped bonded magnet. The preparation method is used for manufacturing the gradient ring-shaped bonded magnet, and includes the following steps:

Step 1: obtaining structural parameters and connection position parameters of a magnet body and a reinforcement layer according to the structure of a motor;

Step 2: obtaining a preform of the magnet body and a preform of the reinforcement layer according to the structural parameters and the connection position parameters; and

Step 3: sleeving, pressing and solidifying the preform of the magnet body and the preform of the reinforcement layer.

Further, a ratio value of the magnet body to the reinforcement layer is a ratio value of a conventional safe area to an easy-to-demagnetize area of the motor under the worst working condition.

Further, in Step 2: the density of the preform of the magnet body and the density of the preform of the reinforcement layer are 3-4 g/cm³; and in Step 3, the density of the gradient ring-shaped bonded magnet finally pressed by a pressing mold is 6.0-6.3 g/cm³.

Further, in Step 3, the solidification temperature is 120° C.-180° C., preferably, the solidification temperature is 150° C.; and the solidification time is 1 hour to 3 hours, preferably, the solidification time is 2 hours.

Correspondingly, a third aspect of the examples of the present application provides a motor, including the gradient ring-shaped bonded magnet.

The above technical solutions of the present application have the following beneficial technical effects: the gradient ring-shaped bonded magnet can realize the local reinforcement of the ring-shaped bonded magnet, effectively improve the demagnetization resistance and the high-temperature resistance of the ring-shaped bonded magnet in the motor application, effectively save the use amount of precious metals such as dysprosium and terbium, and reduce the material cost of the permanent magnet. Furthermore, the preparation method for the gradient ring-shaped bonded magnet provided by the present application has the advantages of simple process, low processing cost, no need of additional equipment and suitability for mass production.

### BRIEF DESCRIPTION OF DRAWINGS

FIG. 1a is a schematic diagram of example 1 of a gradient ring-shaped bonded magnet according to an example of the present application.

FIG. 1b is a schematic diagram of example 2 of a gradient ring-shaped bonded magnet according to an example of the present application.

FIG. 1c is a schematic diagram of example 3 of a gradient ring-shaped bonded magnet according to an example of the present application.

FIG. 1d is a schematic diagram of example 4 of a gradient ring-shaped bonded magnet according to an example of the present application.

FIG. 1e is a schematic diagram of example 5 of a gradient ring-shaped bonded magnet according to an example of the present application.

FIG. 1f is a schematic diagram of example 6 of a gradient ring-shaped bonded magnet according to an example of the present application.

FIG. 2 is a schematic diagram according to a preparation method for a gradient ring-shaped bonded magnet according to an example of the present application.

FIG. 3 is a two-dimensional topological diagram of a 6-groove 4-pole surface-mounted permanent magnet motor according to an example of the present application.

FIG. 4 is a schematic diagram of a surface demagnetization rate of a rotor of a 6-groove 4-pole surface-mounted permanent magnet motor without a gradient ring-shaped bonded magnet according to an example of the present application.

FIG. 5 is a schematic diagram of a surface demagnetization rate of a rotor of a 6-groove 4-pole surface-mounted permanent magnet motor with a gradient ring-shaped bonded magnet according to an example of the present application.

### DETAILED DESCRIPTION OF THE EMBODIMENTS

For making objectives, technical solutions and advantages of the present application clearer, the present application will be further described in detail below in conjunction with specific examples. It should be understood that these descriptions are exemplary only, and are not intended to limit the scope of the present application. In addition, in the following description, descriptions of well-known structures and techniques are omitted to avoid unnecessarily obscuring the concepts of the present application.

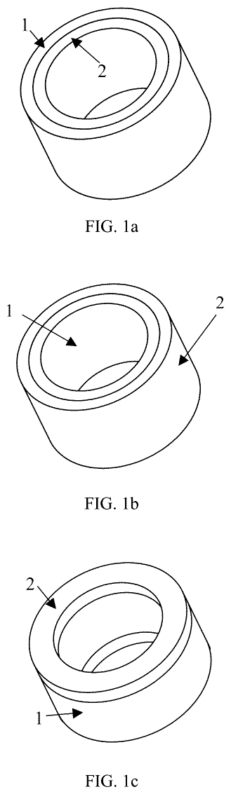

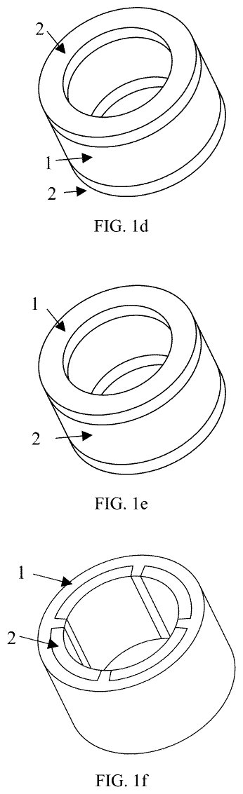

Referring to FIG. 1, to solve the above technical problem, a first aspect of the examples of the present application provides a gradient ring-shaped bonded magnet, including: a magnet body 1 and at least one reinforcement layer 2; the magnet body 1 is a ring-shaped cylinder; the reinforcement layer 2 is in pressing fit with a surface of the magnet body 1; a material of the magnet body 1 is a first permanent magnet, and a material of the reinforcement layer 2 is a second permanent magnet; and the coercivity property, the remanence property and/or the maximum working temperature of the second permanent magnet are/is higher than those of the first permanent magnet.

Specifically, a material of the first permanent magnet and a material of the second permanent magnet include: neodymium iron boron, samarium iron nitrogen and/or samarium cobalt.

A basic material of the second permanent magnet may be the same or different from a basic material of the first permanent magnet. Whether the basic materials of the first permanent magnet and the second permanent magnet are the same or not, as long as the coercivity property, the remanence property and/or the maximum working temperature of the second permanent magnet are/is higher than those of the first permanent magnet.

The structure of the gradient ring-shaped bonded magnet is described below by a plurality of examples.

In example 1 of the gradient ring-shaped bonded magnet, referring to FIG. 1a, a reinforcement layer 2 of the gradient ring-shaped bonded magnet is a ring-shaped cylinder, and an inner wall of a magnet body 1 is in pressing fit with a radial outer wall of the reinforcement layer 2. That is, the ring-shaped cylinder reinforcement layer 2 is sleeved outside the ring-shaped cylinder magnet body, and the ring-shaped cylinder reinforcement layer and the ring-shaped cylinder magnet body are fixed together through pressing fit.

In example 2 of the gradient ring-shaped bonded magnet, referring to FIG. 1b, a reinforcement layer 2 of the gradient ring-shaped bonded magnet is a ring-shaped cylinder, and an outer wall of a magnet body 1 is in pressing fit with a radial inner wall of the reinforcement layer 2. That is, the ring-shaped cylinder magnet body is sleeved outside the ring-shaped cylinder reinforcement layer 2, and the ring-shaped cylinder magnet body and the ring-shaped cylinder reinforcement layer are fixed together through pressing fit.

In example 3 of the gradient ring-shaped bonded magnet, referring to FIG. 1c, a reinforcement layer 2 of the gradient ring-shaped bonded magnet is a ring-shaped cylinder, an inner diameter and an outer diameter of the reinforcement layer are the same as those of a magnet body 1, and axial lengths of the reinforcement layer and the magnet body are different. In a case that one reinforcement layer 2 is provided, the reinforcement layer is arranged on one axial end of the magnet body 1, and an axial side wall of the reinforcement layer 2 is in pressing fit with a side wall of one axial end of the magnet body.

In example 4 of the gradient ring-shaped bonded magnet, referring to FIG. 1d, a reinforcement layer 2 of the gradient ring-shaped bonded magnet is a ring-shaped cylinder, an inner diameter and an outer diameter of the reinforcement layer are the same as those of a magnet body 1, and axial lengths of the reinforcement layer and the magnet body are different. In a case that two reinforcement layers 2 are provided, the reinforcement layers are arranged on two axial ends of the magnet body 1, and an axial side wall of the reinforcement layer 2 is in pressing fit with side walls of two axial ends of the magnet body.

In example 5 of the gradient ring-shaped bonded magnet, referring to FIG. 1e, a reinforcement layer 2 of the gradient ring-shaped bonded magnet is a ring-shaped cylinder, an inner diameter and an outer diameter of the reinforcement layer are the same as those of a magnet body 1, and axial lengths of the reinforcement layer and the magnet body are different. In a case that one reinforcement layer 2 is provided and magnet bodies 1 are two same parts which are respectively located at two axial ends of the reinforcement layer 2, axial side walls of the two magnet bodies 1 are in pressing fit with side walls of two axial ends of the reinforcement layer 2, respectively.

In example 6 of the gradient ring-shaped bonded magnet, referring to FIG. 1f, a radial inner wall of the magnet body 1 is provided with a plurality of grooves; the reinforcement layer 2 includes arc-sheet-shaped reinforcement bodies matched with the shapes of the grooves; and the reinforcement bodies are arranged in the grooves, and the reinforcement bodies are in pressing fit with the bottoms of the grooves of the magnet bodies 1.

In example 7 of the gradient ring-shaped bonded magnet, referring to FIG. 1g, a radial outer wall of the magnet body 1 is provided with a plurality of grooves; the reinforcement layer 2 includes arc-sheet-shaped reinforcement bodies matched with the shapes of the grooves; and the reinforcement bodies are arranged in the grooves, and the reinforcement bodies are in pressing fit with the bottoms of the grooves of the magnet bodies 1.

The magnet body 1 and the reinforcement layer 2 adopt different materials or materials with different reference signs, the specific location of the reinforcement layer 2 is determined based on the structure and application requirement of the motor, the specific sizes of the magnet body 1 and the reinforcement layer 2 are determined through calculation, corresponding preforms are manufactured, and finally, the two preforms are sleeved, pressed and solidified to obtain an overall ring-shaped magnet structure.

On the basis that a part, close to a stator armature, of the surface-mounted permanent magnet motor or a part on the edge of the magnet is prone to demagnetization, the gradient ring-shaped bonded magnet tries to perform local reinforcement on one side or an edge area, close to the stator armature, of the ring-shaped bonded magnet, a ring-shaped bonded magnet processing process is combined, a reinforcement layer pre-pressing ring and a conventional layer pre-pressing ring are increased, and then a plurality of pre-pressing rings are sleeved together to perform the final pressing and solidification methods, thereby achieving the local reinforcement of the ring-shaped bonded magnet.

Correspondingly, a second aspect of the examples of the present application provides a preparation method for a gradient ring-shaped bonded magnet. The preparation method is used for manufacturing the gradient ring-shaped bonded magnet, and includes the following steps:

Step 1: structural parameters and connection position parameters of a magnet body 1 and a reinforcement layer 2 were obtained according to the structure of a motor;

Step 2: a preform of the magnet body 1 and a preform of the reinforcement layer 2 were obtained according to the structural parameters and the connection position parameters; and

Step 3: the preform of the magnet body 1 and the preform of the reinforcement layer 2 were sleeved, pressed and solidified to obtain the gradient ring-shaped bonded magnet.

Further, a ratio value of the magnet body to the reinforcement layer is a ratio value of a conventional safe area to an easy-to-demagnetize area of the motor under the worst working condition.

Further, in Step 2: the density of the preform of the magnet body and the density of the preform of the reinforcement layer are 3-4 g/cm³; and

in Step 3, the density of the gradient ring-shaped bonded magnet finally pressed by a pressing mold is 6.0-6.3 g/cm³.

Further, in Step 3, the solidification temperature is 120° C.-180° C., preferably, the solidification temperature is 150° C.; and the solidification time is 1 hour to 3 hours, preferably, the solidification time is 2 hours.

The preparation method is described in detail below by a plurality of examples.

### EXAMPLE 1

When a bonded magnet ring permanent motor with an inner diameter of 18 mm, an outer diameter of 26 mm and a height of 20 mm is used, the demagnetization of the motor occurs on a surface layer under the worst working condition through calculation, and the distribution depth is about 1.5 mm. According to the calculation, the reinforcement layer is set as the surface layer of the bonded magnet ring and has a thickness of 1.5 mm, and the magnet body has a thickness of 2.5 mm. Further, the magnet property of the permanent magnet motor using the bonded magnet ring when demagnetization does not occur on the surface layer of the magnet under the worst working condition is obtained through simulating calculation, and magnetic powder with the brand is chosen for pressing.

Firstly, a reinforcement layer pre-pressing ring with an inner diameter of 23 mm, an outer diameter of 26 mm, a height of 40 mm and a density of 3.0 g/cm³, and a magnet ring body layer with an inner diameter of 18 mm, an outer diameter of 23 mm, a height of 40 mm and a density of 3.0 g/cm³ were manufactured through pre-pressing; then the reinforcement layer and the body layer were assembled and were put into a final press to be pressed into a final bonded magnet ring blank with an inner diameter of 18 mm, an outer diameter of 26 mm, a height of 20 mm and a density of 6.0 g/cm³; and the bonded magnet ring blank was placed into a 150° C. drying oven and was heated for 2 hours to complete the final solidification.

### EXAMPLE 2

When a bonded magnet ring permanent motor with an inner diameter of 22 mm, an outer diameter of 30 mm and a height of 15 mm is used, the demagnetization of the motor occurs on a surface layer under the worst working condition through calculation, and the distribution depth is about 1.8 mm. According to the calculation, the reinforcement layer is set as the surface layer of the bonded magnet ring and has a thickness of 1.8 mm, and the magnet body has a thickness of 2.2 mm. Further, the magnet property of the permanent magnet motor using the bonded magnet ring when demagnetization does not occur on the surface layer of the magnet under the worst working condition is obtained through simulating calculation, and magnetic powder with the brand is chosen for pressing.

Firstly, a reinforcement layer pre-pressing ring with an inner diameter of 22 mm, an outer diameter of 25.6 mm, a height of 30 mm and a density of 4.0 g/cm³, and a magnet ring body layer with an inner diameter of 25.6 mm, an outer diameter of 30 mm, a height of 30 mm and a density of 4.0 g/cm³ were manufactured through pre-pressing; then the reinforcement layer and the body layer were assembled and were put into a final press to be pressed into a final bonded magnet ring blank with an inner diameter of 22 mm, an outer diameter of 30 mm, a height of 15 mm and a density of 6.2 g/cm³; and the bonded magnet ring blank was placed into a 120° C. drying oven and was heated for 3 hours to complete the final solidification.

### EXAMPLE 3

When a bonded magnet ring permanent motor with an inner diameter of 16 mm, an outer diameter of 22 mm and a height of 15 mm is used, the demagnetization of the motor occurs on a surface layer under the worst working condition through calculation, and the distribution depth is about 1 mm. According to the calculation, the reinforcement layer is set as the surface layer of the bonded magnet ring and has a thickness of 1 mm, and the magnet body has a thickness of 2 mm. Further, the magnet property of the permanent magnet motor using the bonded magnet ring when demagnetization does not occur on the surface layer of the magnet under the worst working condition is obtained through simulating calculation, and magnetic powder with the brand is chosen for pressing.

Firstly, a reinforcement layer pre-pressing ring with an inner diameter of 16 mm, an outer diameter of 18 mm, a height of 30 mm and a density of 3.5 g/cm³, and a magnet ring body layer with an inner diameter of 18 mm, an outer diameter of 22 mm, a height of 30 mm and a density of 3.5 g/cm³ were manufactured through pre-pressing; then the reinforcement layer and the body layer were assembled and were put into a final press to be pressed into a final bonded magnet ring blank with an inner diameter of 16 mm, an outer diameter of 22 mm, a height of 15 mm and a density of 6.3 g/cm³; and the bonded magnet ring blank was placed into a 180° C. drying oven and was heated for 1 hours to complete the final solidification.

Correspondingly, a third aspect of the examples of the present application provides a motor, including the gradient ring-shaped bonded magnet.

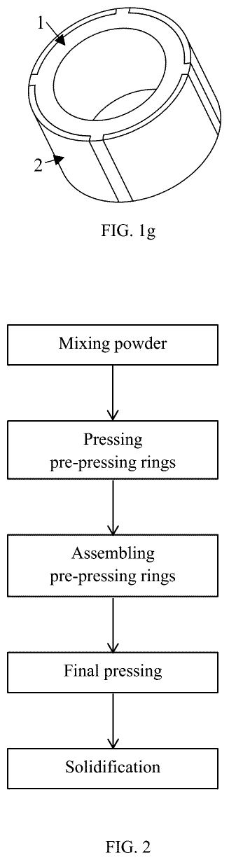

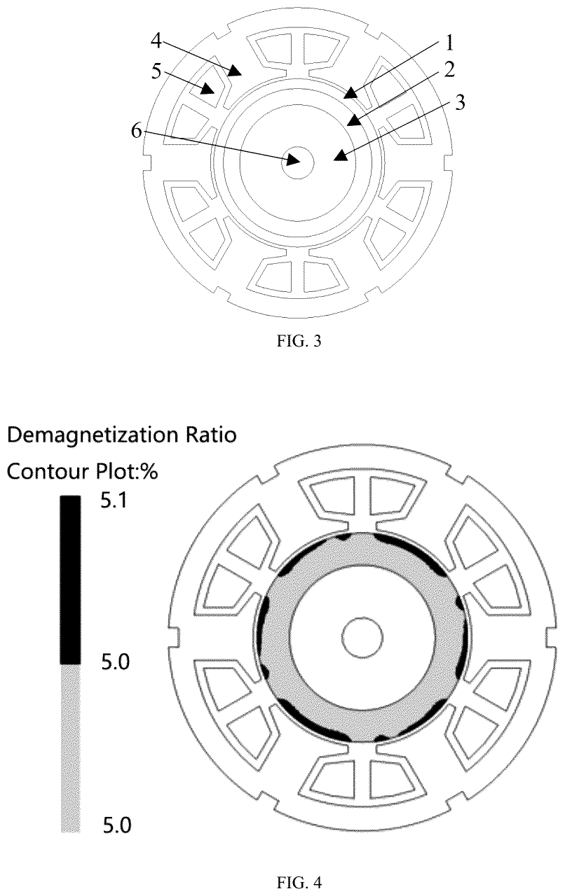

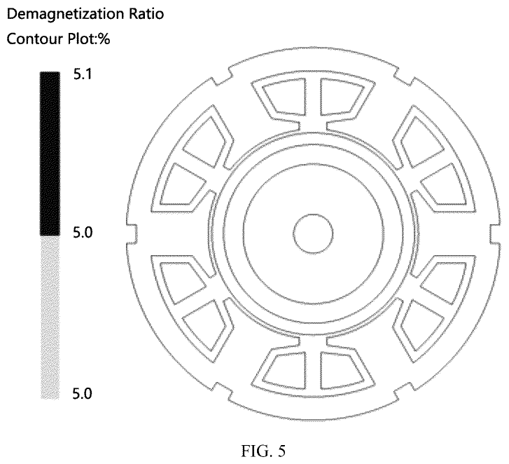

Referring to FIG. 3, FIG. 4 and FIG. 5, in one specific example, FIG. 3 is a two-dimensional topological diagram of a 6-groove 4-pole surface-mounted permanent magnet motor, which sequentially includes a motor rotating shaft 6, a motor rotor iron core 3, a reinforcement layer 2, a magnet body 1, a motor stator iron core 4 and a motor stator winding 5 from inside to outside in a radial direction.

In the above example, a four-pole ring-shaped bonded permanent magnet with an outer diameter of 26 mm and an inner diameter of 18 mm is used, and the ring-shaped permanent magnet is applied to a 6-groove 4-pole surface-mounted permanent magnet motor. The structure of the motor is shown in FIG. 3. Firstly, the thickness was calculated when the demagnetization rate of the surface layer of the conventional ring-shaped permanent magnet rotor structure of the motor under the worst working condition is greater than 5%, as shown in FIG. 4, an area where the demagnetization rate is greater than 5% has a thickness of 1.5 mm. Then, high-coercivity magnetic powder was selected according to the calculated thickness, the powder was mixed, a pre-pressing reinforcement layer magnet with an outer diameter of 26 mm and an inner diameter of 23 mm was pressed, a conventional layer magnet with an outer diameter of 23 mm and an inner diameter of 18 mm was pressed after the original conventional magnetic powder was mixed, two pre-pressing rings were assembled together after being completed and then are placed into a final mold for final pressing to obtain the gradient ring-shaped bonded magnet with an outer diameter of 26 mm and an inner diameter of 18 mm, and the bonded magnet was solidified. After solidification was completed, the gradient ring-shaped bonded magnet was assembled into a target motor for test. The test result is shown in FIG. 5. Under the same working condition, the area where the demagnetization rate of the surface-mounted permanent magnet motor using the gradient ring-shaped bonded magnet is greater than 5% is almost 0.

The examples of the present application aim to protect a gradient ring-shaped bonded magnet and a preparation method therefor, and a motor. The gradient ring-shaped bonded magnet includes: a magnet body and at least one reinforcement layer. The magnet body is a ring-shaped cylinder; the reinforcement layer is in pressing fit with a surface of the magnet body; a material of the magnet body is a first permanent magnet, and a material of the reinforcement layer is a second permanent magnet; and the coercivity property, the remanence property and/or the maximum working temperature of the second permanent magnet are/is higher than those of the first permanent magnet.

The above technical solutions have the following effects: the gradient ring-shaped bonded magnet can realize the local reinforcement of the ring-shaped bonded magnet, effectively improve the demagnetization resistance and the high-temperature resistance of the ring-shaped bonded magnet in the motor application, effectively save the use amount of precious metals such as dysprosium and terbium, and reduce the material cost of the permanent magnet. Furthermore, the preparation method for the gradient ring-shaped bonded magnet provided by the present application has the advantages of simple process, low processing cost, no need of additional equipment and suitability for mass production.

It should be understood that, the foregoing specific examples of the present application are only used to illustrate or explain the principle of the present application, but not to limit the present application. Therefore, any modification, equivalent replacement, improvement and the like made without departing from the spirit and scope of the present application should be included within the protection scope of the present application. In addition, the appended claims of the present application are intended to cover all changes and modifications that fall within the scope and boundary of the appended claims, or equivalence of such scope and boundary.

What is claimed is:

1. A gradient ring-shaped bonded magnet, comprising a magnet body and at least one reinforcement layer,
wherein the magnet body is a ring-shaped cylinder;
the reinforcement layer is in pressing fit with a surface of the magnet body; and
a material of the magnet body is a first permanent magnet, a material of the reinforcement layer is a second permanent magnet, and a coercivity property, a remanence property and/or a maximum working temperature of the second permanent magnet are/is higher than those of the first permanent magnet.

2. The gradient ring-shaped bonded magnet according to claim 1, wherein
a material of the first permanent magnet and a material of the second permanent magnet comprise: neodymium iron boron, samarium iron nitrogen and/or samarium cobalt.

3. The gradient ring-shaped bonded magnet according to claim 1, wherein
the reinforcement layer is a ring-shaped cylinder;
an inner wall of the magnet body is in pressing fit with a radial outer wall of the reinforcement layer; or
an outer wall of the magnet body is in pressing fit with a radial inner wall of the reinforcement layer.

4. The gradient ring-shaped bonded magnet according to claim 1, wherein
the reinforcement layer is a ring-shaped cylinder, and an inner diameter and an outer diameter of the reinforcement layer are the same as those of the magnet body;
in a case that one reinforcement layer is provided, an axial side wall of the reinforcement layer is in pressing fit with a side wall of one axial end of the magnet body; or
in a case that one reinforcement layer is provided, the magnet body comprises a first body and a second body which are ring-shaped cylinders, a side wall of one axial end of each of the first body and the second body is in pressing fit with side walls of two axial ends of the reinforcement layer, respectively; or
in a case that two reinforcement layers are provided, axial side walls of the reinforcement layers are in pressing fit with side walls of two axial ends of the magnet body.

5. The gradient ring-shaped bonded magnet according to claim 1, wherein
a radial inner wall or a radial outer wall of the magnet body is provided with a plurality of grooves;
the reinforcement layer comprises a plurality of arc-sheet-shaped reinforcement bodies matched with the shapes of the grooves; and
the reinforcement bodies are arranged in the grooves, and the reinforcement bodies are in pressing fit with the bottoms of the grooves.

6. A preparation method for a gradient ring-shaped bonded magnet, used for manufacturing the gradient ring-shaped bonded magnet according to claim 1, and comprising following steps:
Step 1: obtaining structural parameters and connection position parameters of a magnet body and a reinforcement layer according to the structure of a motor;
Step 2: obtaining a preform of the magnet body and a preform of the reinforcement layer according to the structural parameters and the connection position parameters; and
Step 3: sleeving, pressing and solidifying the preform of the magnet body and the preform of the reinforcement layer to obtain the gradient ring-shaped bonded magnet.

7. The preparation method for the gradient ring-shaped bonded magnet according to claim 6, wherein
a ratio value of the magnet body to the reinforcement layer is a ratio value of a conventional safe area to an easy-to-demagnetize area of the motor under the worst working condition.

8. The preparation method for the gradient ring-shaped bonded magnet according to claim 6, wherein
in Step 2: a density of the preform of the magnet body and a density of the preform of the reinforcement layer are 3-4 g/cm³; and
in Step 3, a density of the gradient ring-shaped bonded magnet finally pressed by a pressing mold is 6.0-6.3 g/cm³.

9. The preparation method for the gradient ring-shaped bonded magnet according to claim 6, wherein
in Step 3, a solidification temperature is 120° C.-180° C., preferably, the solidification temperature is 150° C.; and
the solidification time is 1 hour to 3 hours, preferably, the solidification time is 2 hours.

10. A motor, comprising the gradient ring-shaped bonded magnet according to claim 1.
